(19) United States
(12) Patent Application Publication
(10) Pub. No.: US 2026/0354424 A1
(43) Pub. Date: Nov. 12, 2026

(54) COOKING PROGRAM FOR COOKING MULTIPLE FOOD ITEMS

(71) Applicant: Electrolux Consumer Products, Inc., Charlotte, NC (US)

(72) Inventors: Sara Little, Clarksville, TN (US); Laura Wade, Portland, TN (US)

(21) Appl. No.: 19/201,261

(22) Filed: May 7, 2025

(51) Int. Cl. A23L 5/10; A47J 36/32

(52) U.S. Cl. CPC A23L 5/15; A47J 36/32

(57) ABSTRACT

A non-transitory computer-readable medium includes a cooking program for a cooking appliance having a cooking cavity, a heating system with at least one heating element, and a controller that is operatively coupled to the heating system. Execution of the cooking program by the controller causes the controller to perform a preheat operation until a final preheat condition is satisfied, wherein the preheat operation includes operating the heating system to preheat the cooking cavity; perform a decision operation that comprises determining whether a first cooking condition or a second cooking condition is satisfied; perform a first cooking operation in response to the first cooking condition being satisfied; and perform a second cooking operation in response to the second cooking condition being satisfied, wherein the second cooking operation is different from the first cooking operation.

### TECHNICAL FIELD

The present disclosure relates to a cooking program for cooking multiple food items and, more particularly, a cooking program for cooking multiple food items sequentially.

### BACKGROUND

Domestic cooking appliances can include a cooking cavity, a heating system having one or more heating elements for heating air within the cooking cavity, and a controller that can operate the heating system according to one or more cooking programs for cooking food items in the cooking cavity. Each cooking program can include a preheat operation that is designed to preheat the cooking cavity before the food item is placed therein, and a cooking operation that is designed to cook the food item after it is placed in the cooking cavity. In some examples, a cooking program may provide the ability to repeat the cooking operation in the event that the user wants to cook a second food item that is substantially similar to the first food item in type, size, weight, shape, etc.

However, the present inventors have found that, depending on various factors such as timing and the state of the cooking cavity after cooking the first food item, repeating the same cooking operation for the second food item may produce different results, even though the first and second food items are substantially similar. This can particularly occur if the cooking operation is a high-heat cooking operation for cooking food items such as pizza at high heat (e.g., 700 °F), since the timing in which the second food item is placed in the cooking cavity and the cooking operation is repeated can dramatically influence the cooking process. Accordingly, described herein is a cooking program for a cooking appliance that can sequentially cook multiple food items, wherein a decision operation is performed between food items to determine whether to repeat the same cooking operation or use a different cooking operation for the next food item.

### BRIEF SUMMARY

According to a first aspect, a non-transitory computer-readable medium includes a cooking program for a cooking appliance having a cooking cavity, a heating system with at least one heating element that is operable to heat air within the cooking cavity, and a controller that is operatively coupled to the heating system. Execution of the cooking program by the controller causes the controller to perform a preheat operation until a final preheat condition is satisfied, wherein the preheat operation includes operating the heating system to preheat the cooking cavity; perform a decision operation that comprises determining whether a first cooking condition or a second cooking condition is satisfied; perform a first cooking operation in response to the first cooking condition being satisfied; and perform a second cooking operation in response to the second cooking condition being satisfied, wherein the second cooking operation is different from the first cooking operation.

In one example, the preheat operation includes performing an initial preheating stage until an initial preheat condition is satisfied, the initial preheating stage including operating the heating system according to an initial preheat power scheme that is based on an initial preheat target temperature.

In another example, the initial preheat condition is based on a predetermined threshold time.

In yet another example, the preheat operation includes performing a final preheating stage after the initial preheating stage, wherein the final preheating stage includes the controller providing an output signal to a user interface of the cooking appliance.

In still yet another example, the final preheating stage includes operating the heating system according to a final preheat power scheme that is based on a final preheat target temperature, wherein the final preheat target temperature is less than the initial preheat target temperature.

In still yet another example, the preheat operation comprises performing the second preheating stage until the final preheat condition is satisfied, wherein the final preheat condition comprises the controller receiving an input signal.

In another example, the first cooking operation and second cooking operation each include operating the heating system according to a power scheme until a cooking condition is satisfied, the cooking condition of the first cooking operation being different than the cooking condition of the second cooking operation.

In yet another example, for each of the first cooking operation and second cooking operation, the cooking condition is based on a predetermined threshold time, wherein the predetermined threshold time of the first cooking operation is different than the predetermined threshold time of the second cooking operation.

In still yet another example, the first cooking operation and second cooking operation each include a low-power cooking operation that includes operating the heating system according to a low-power scheme until a low-power condition is satisfied, and a high-power cooking operation that includes operating the heating system according to a high-power scheme until a high-power condition is satisfied, the high-power scheme providing greater power to the heating system than the low-power scheme.

In another example, the low-power scheme continuously de-energizes the heating system until the low-power condition is satisfied, and the high-power scheme continuously energizes the heating system until the high-power condition is satisfied.

In yet another example, the low-power condition and high-power condition of the first cooking operation are respectively different than the low-power condition and high-power condition of the second cooking operation.

In still yet another example, for each of the first cooking operation and second cooking operation, the low-power condition is based on a predetermined threshold time, wherein the predetermined threshold time of the first cooking operation is different than the predetermined threshold time of the second cooking operation.

In another example, for each of the first cooking operation and second cooking operation, the high-power condition is based on a predetermined threshold time, wherein the predetermined threshold time of the first cooking operation is different than the predetermined threshold time of the second cooking operation.

In yet another example, the high-power operation is performed in response to the low-power condition being satisfied.

In still yet another example, the first cooking operation and second cooking operation each include a high-power cooking operation that includes operating the heating system according to a high-power scheme until a high-power condition is satisfied, and an idle-power cooking operation that is performed in response to the high-power condition being satisfied. The idle-power operation includes providing an output signal to a user interface of the cooking appliance, and operating the heating system according to an idle-power scheme that provides less power to the heating system than the high-power scheme.

In another example, the idle-power operation includes determining whether a first idle condition is satisfied, wherein the controller terminates the cooking program in response to the first idle condition being satisfied. The idle-power operation further includes determining whether a second idle condition is satisfied, wherein the controller terminates the idle-power operation and performs a reheat operation in response to the second idle condition being satisfied.

In yet another example, the reheat operation includes performing a first reheating stage until a first reheat condition is satisfied, the first reheating stage including operating the heating system according to a first reheat power scheme, and performing a second reheating stage in response to the first reheat condition being satisfied. The second reheating stage includes providing an output signal to a user interface of the cooking appliance, and operating the heating system according to a second reheat power scheme until a second reheat condition is satisfied, wherein the second reheat condition includes the controller receiving an input signal.

In still yet another example, the first reheat power scheme is based on a first reheat target temperature, and the first reheat condition is based on a predetermined threshold time.

In another example, the decision operation is performed in response to the second reheat condition being satisfied.

In yet another example, the decision operation includes determining whether the first cooking condition is satisfied, and execution of the cooking program by the controller causes the controller to perform the first cooking operation in response to the first cooking condition being satisfied, and perform the second cooking operation in response to the first cooking condition being unsatisfied.

In still yet another example, a method includes executing the cooking program of the non-transitory computer-readable medium, wherein execution of the cooking program causes the controller of the cooking appliance to perform the preheat operation until the final preheat condition is satisfied, perform the decision operation, perform the first cooking operation in response to the first cooking condition being satisfied, and perform the second cooking operation in response to the second cooking condition being satisfied.

### BRIEF DESCRIPTION OF THE DRAWINGS

FIG. 1 is a schematic side view, in cross-section, of an example cooking appliance;

FIG. 2 shows an example high-heat cooking operation for the cooking appliance;

FIG. 3 shows various details of first and second preheating stages of a preheat operation of the high-heat cooking operation;

FIG. 4 shows various details of a third preheating stage of the preheat operation;

FIG. 5 shows various details of a first cooking operation of the high-heat cooking operation;

FIG. 6 shows other various details of the first cooking operation;

FIG. 7 shows various details of a reheat operation of the high-heat cooking operation; and

FIG. 8 shows various details of a decision operation of the high-heat cooking operation;

### DETAILED DESCRIPTION

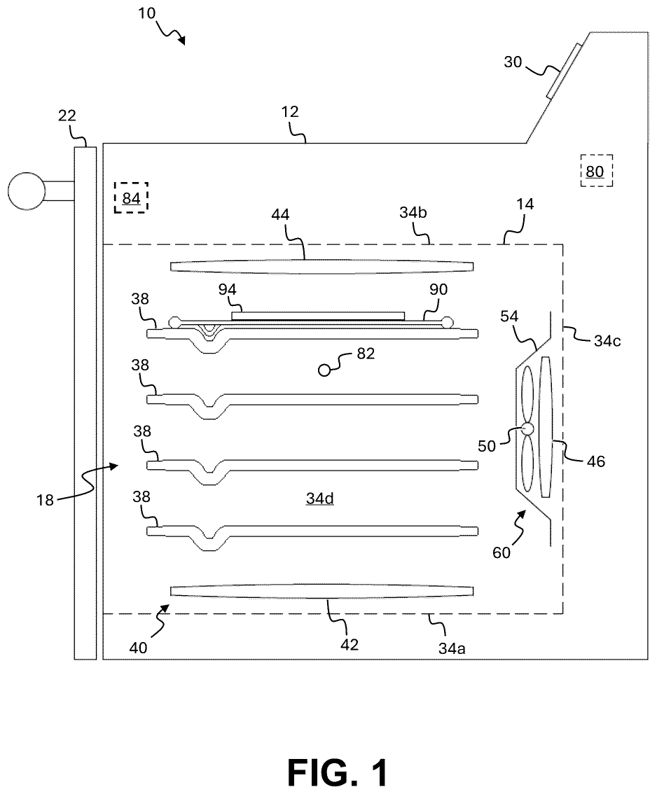

Turning to FIG. 1, an example cooking appliance 10 is illustrated having a housing 12, a cooking compartment 14 that defines a cooking cavity 18, a door 22 pivotally attached to the housing 12 that provides selective access to the cavity 18, and a control panel having a user interface 30. The compartment 14 has a plurality of walls 34 that define the cavity 18, including a lower wall 34a, an upper wall 34b, a rear wall 34c, and a pair of opposing side walls 34d (only the left-side wall 34d is visible in FIG. 1), wherein each side wall 34d has a plurality of rack supports 38 that are vertically spaced and can receive a rack for supporting food items within the cavity 18..

The appliance 10 further includes a heating system 40 that can be operated (e.g., controlled) to heat air within the cavity 18 to perform various cooking operations. In the present embodiment, the heating system 40 includes a lower heating element 42 (“bake element”) arranged at or adjacent to the lower wall 34a of the compartment 14, an upper heating element 44 (“broil element”) arranged at or adjacent to the upper wall 34b of the compartment 14, and a rear heating element 46 (“convection element”) arranged at or adjacent to the rear wall 34c of the compartment 14. Moreover, the heating system 40 further includes a convection fan 50 for circulating air across the convection element 46 and within the cavity 18. The convection element 46 and convention fan 50 are covered by a protective shroud 54 and collectively form a convection system 60 of the appliance 10.

Each heating element 42, 44, 46 of the heating system 40 may be an electric-resistive body (e.g., coil) that converts electrical energy supplied thereto into heat, or a gas burner that burns gas supplied thereto to generate heat. Moreover, each heating element 42, 44, 46 may be located within or outside of the cavity 18, adjacent to its associated compartment wall 34. Still further, the heating system 40 may comprise additional or fewer heating elements in other examples, with or without the convection fan 50. Broadly speaking, the heating system 40 can include any configuration of one or more heating elements that can be operated to heat air within the cooking cavity 18.

The appliance 10 further includes a controller 80 (e.g., programmable logic controller) having a processor and memory, which is operatively coupled (e.g., via one or more wires, relays, digital gas valves, etc.) to the heating elements 42, 44, 46 and convection fan 50 of the heating system 40 such that the controller 80 can operate the heating system 40 to perform various cooking operations. Moreover, the controller 80 is in communication with the user interface 30, which has one or more input elements (e.g., switches, buttons, touchscreens, etc.) that a user can manipulate to provide one or more input signals (e.g., program selections, start commands, temperature settings, etc.) to the controller 80. The user interface 30 also has one or more output elements (e.g., speakers, displays, lights, etc.) that can provide one or more outputs (e.g., program selection screens, cooking operation settings and statuses, sounds, lights, etc.) to convey information to the user.

The appliance 10 also includes a temperature sensor 82 that is configured to measure a temperature Tₘ of air within the cavity 18 and provide an output signal to the controller 80 indicative of the measured temperature Tₘ. Moreover, the appliance 10 includes a door sensor 84 that is configured to detect a position of the door 22 and provide an output signal to the controller 80 indicative of the detected position. For example, if the door 22 is in a closed position, the door sensor 84 can provide a positive signal to the controller 80 indicating that the door 22 is closed. Conversely, if the door 22 in an open position, the door sensor 84 can provide a zero signal to the controller 80 indicating that the door 22 is open.

The controller 80 of the appliance 10 can be configured to execute one or more cooking programs, which can be stored in a non-transitory computer-readable medium such as the memory of the controller 80 or a remote server that is in communication with the controller 80. For instance, the controller 80 in the present example has a high-heat cooking program stored in its memory that the controller 80 will execute in response to receiving an associated start command from the user interface 30, wherein execution of the high-heat cooking program will cause the controller 80 to perform a high-heat cooking operation 100 described below. The high-heat cooking operation 100 is particularly useful for cooking pizza at high heat, and can be executed while a rack 90 is arranged on the upper-most rack supports 38 of the side walls 34d, with a ceramic cooking stone 94 placed on the rack 90 and centered directly below the broil element 44. Of course, the rack 90 may be arranged in other positions within the cavity 18, with or without the cooking stone 94 placed thereon. Moreover, the high-heat cooking operation 100 may be used to cook other food items besides pizza.

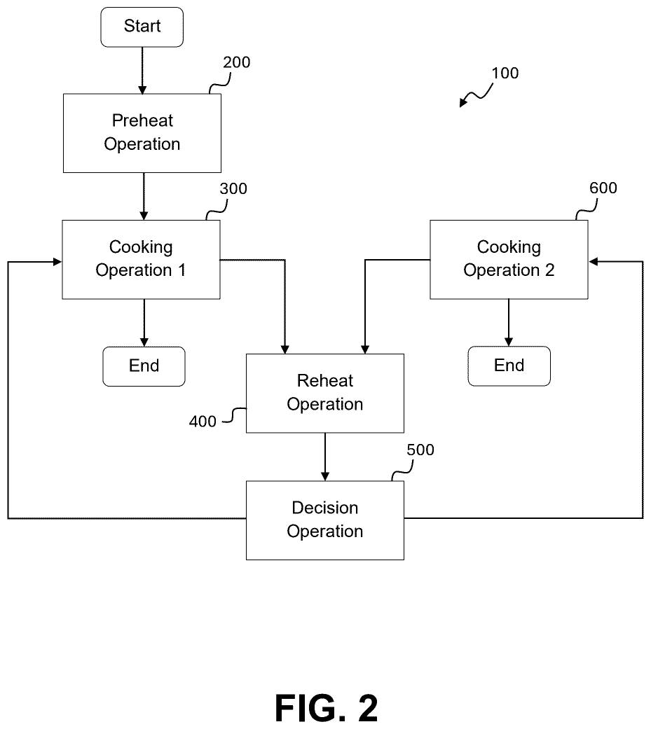

FIG. 2 broadly illustrates the high-heating cooking operation 100 and its sub-operations 200, 300, 400, 500, 600. Broadly speaking, the high-heating cooking operation 100 has a preheat operation 200 that will preheat the cooking cavity 18 and the cooking stone 94, preferably without any food items on the cooking stone 94. Once the cooking cavity 18 and cooking stone 94 are preheated, a user can place a first food item (e.g., pizza) on the cooking stone 94, and the high-heating cooking operation 100 will proceed to a first cooking operation 300 that will cook the first food item.

Once the first food item has been cooked via the first cooking operation 300, the high-heating cooking operation 100 can end. Alternatively, a user can provide an input to the controller 80 (e.g., via the user interface 30) indicating that the user would like to cook a second food item. Upon receiving the input, the controller 80 will perform a reheat operation 400, which is designed to reheat the cooking cavity 18 and cooking stone 94 to an appropriate temperature for further cooking. Moreover, once the cooking cavity 18 and cooking stone 94 are reheated, a user can place the second food item (e.g., pizza) on the cooking stone 94, and the high-heating cooking operation 100 will proceed to a decision operation 500 that will determine whether to repeat the first cooking operation 300 or perform a different cooking operation based on one more conditions of the appliance 10 and high-heat cooking operation 100.

For example, depending on the timing at which the second food item is placed on the cooking stone 94 during the reheat operation 400, cooking the second food item with the first cooking operation 300 may produce results that are different from the first food item. Accordingly, the decision operation 500 may determine that a second cooking operation 600 should be performed that is similar to the first cooking operation 300 but has been adjusted to produce similar results for the second food item. Once the second food item has been cooked via the second cooking operation 600, the high-heating cooking operation 100 can end or a user can provide an input to the controller 80 (e.g., via the user interface 30) indicating that the user would like to cook another food item. Upon receiving the input, the controller 80 will again perform the reheat operation 400, followed by the decision operation 500 and either the first cooking operation 300 or second cooking operation 600. In this manner, the high-heating cooking operation 100 can sequentially cook multiple food items and determine which cooking operation 300, 600 should be performed for each food item subsequent to the first food item, based on conditions evaluated during the decision operation 500.

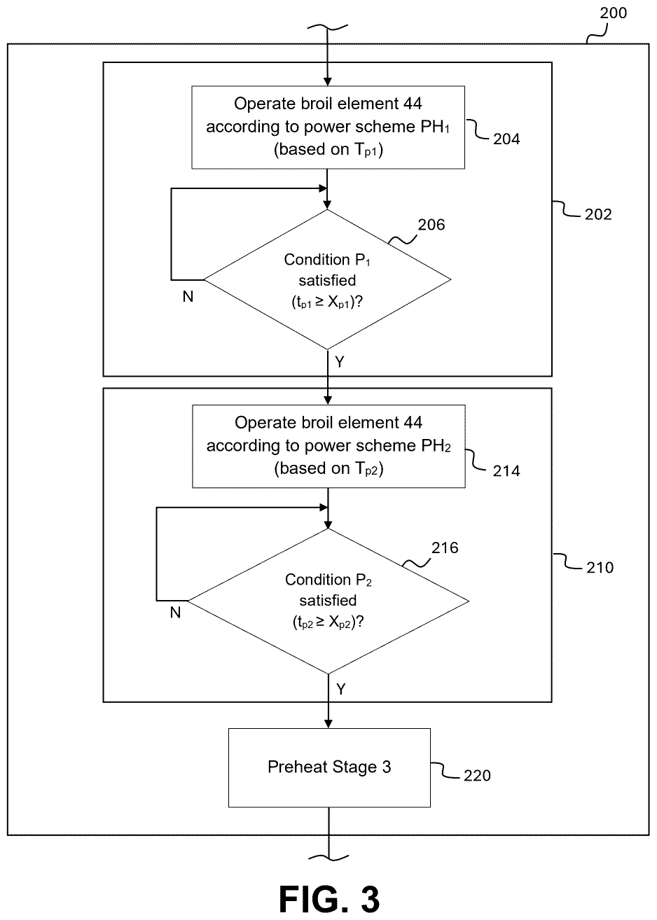

Turning to FIG. 3, the preheat operation 200 of the high-heating cooking operation 100 will now be described in further detail. The preheat operation 200 includes a first (e.g., initial) preheating stage 202 that is designed to bring both the cooking cavity 18 and the cooking stone 94 up to a high temperature for cooking. During the first preheating stage 202, the controller 80 will operate (e.g., control) the broil element 44 of the heating system 40 according to a first preheat power scheme PH₁ until a first preheat condition P₁ is satisfied. In particular, the first preheating stage 202 includes an initial step 204 that will operate the broil element 44 according to the first preheat power scheme PH₁, and another step 206 that will determine whether the first preheat condition P₁ is satisfied, wherein the first preheat condition P₁ comprises a time tₚ₁ of operating the broil element 44 according to the first preheat power scheme PH₁ being greater than or equal to a predetermined threshold time Xₚ₁. If the first preheat condition P₁ is not satisfied, the controller 80 will continue to operate the broil element 44 according to the first preheat power scheme PH₁. However, once the first preheat condition P₁ becomes satisfied, the controller 80 will cease the first preheating stage 202 and proceed to a second preheating stage 210 of the preheating operation 200.

For the purposes of this disclosure, a “power scheme” for a heating element can be any scheme that is predetermined (e.g., stored in the memory of the controller 80) and regulates power supplied to the heating element by regulating the rate of energy (e.g., electricity or gas) supplied thereto. For example, a power scheme can regulate (i.e., adjust or maintain) power supplied to the heating element by continuously energizing the heating element with a constant rate of energy, continuously de-energizing the heating element, varying (e.g., cycling) the rate of energy supplied to heating element, or combinations thereof.

The first preheat power scheme PH₁ in the present example is based on a first target preheat temperature Tₚ₁ (e.g., 550 °F), which is a fixed temperature that is predetermined and stored in the memory of the controller 80. In other examples, the first target preheat temperature Tₚ₁ can be a user-set temperature that is set and provided to the controller 80 via the user interface 30, or an offset temperature that corresponds to a user-set temperature plus a positive or negative offset. The first preheat power scheme PH₁ will continuously energize the broil element 44 at full power until the temperature Tₘ measured by the temperature sensor 82 is equal to or greater than the first target preheat temperature Tₚ₁, and then cycle the broil element 44 according to a predetermined duty cycle to maintain the measured temperature Tₘ about the first target preheat temperature Tₚ₁.

The first preheat power scheme PH₁ of the first preheating stage 202 is thus designed to quickly raise the temperature of air within the cooking cavity 18 up to the first target preheat temperature Tₚ₁. However, the cooking stone 94 is typically slower to heat up and requires more time under the first preheat power scheme PH₁ to reach the first target preheat temperature Tₚ₁ (or higher). Accordingly, the first preheating stage 202 is configured to keep operating the broil element 44 according to the first preheat power scheme PH₁ until the time tₚ₁ of operating the broil element 44 according to the first preheat power scheme PH₁ is greater than or equal to the predetermined threshold time Xₚ₁. Moreover, the predetermined threshold time Xₚ₁ is preferably a sufficient amount of time for the cooking stone 94 to reach a high temperature sufficient for cooking. In the present example, the predetermined threshold time Xₚ₁ is about 28 minutes. This amount of time and the close proximity of the cooking stone 94 to the broil element 44 can enable the cooking stone 94 to reach a temperature of about 750 °F for cooking.

Once the first preheat condition P₁ becomes satisfied, the cooking stone 94 should be sufficiently heated for cooking. However, it is preferable that the surrounding air within the cooking cavity 18 be slightly lowered in temperature before cooking begins. Accordingly, once the first preheat condition P₁ becomes satisfied, the controller 80 will cease the first preheating stage 202 and proceed to a second (e.g., intermediate) preheating stage 210 of the preheating operation 200, which is designed to reduce the heat output of the broil element 44 for a short period of time (e.g., 2 minutes) in order to reduce the temperature of air within the cooking cavity 18 without significantly reducing the temperature of the cooking stone 94.

During the second preheating stage 210, the controller 80 will operate (e.g., control) the broil element 44 of the heating system 40 according to a second preheat power scheme PH₂ until a second preheat condition P₂ is satisfied. In particular, the second preheating stage 210 includes an initial step 214 that will operate the broil element 44 according to the second preheat power scheme PH₂, and another step 216 that will determine whether the second preheat condition P₂ is satisfied, wherein the second preheat condition P₂ comprises a time tₚ₂ of operating the broil element 44 according to the second preheat power scheme PH₂ being greater than or equal to a predetermined threshold time Xₚ₂ (e.g., 2 minutes). If the second preheat condition P₂ is not satisfied, the controller 80 will continue to operate the broil element 44 according to the second preheat power scheme PH₂. However, once the second preheat condition P₂ becomes satisfied, the controller 80 will cease the second preheating stage 210 and proceed to a third preheating stage 220 of the preheating operation 200.

The second preheat power scheme PH₂ of the second preheating stage 210 is designed to effectively deenergize the broil element 44 for the entire stage 210. In particular, the second preheat power scheme PH₂ is based on a second target preheat temperature Tₚ₂ (e.g., 510 °F) that is considerably less than the first target preheat temperature Tₚ₁ (e.g., 550 °F) of the first preheating stage 202. The second target preheat temperature Tₚ₂ is predetermined and can be a fixed temperature stored in the memory of the controller 80, a user-set temperature that is set and provided to the controller 80 via the user interface 30, or a calculated temperature that corresponds to a user-set temperature plus a positive or negative predetermined offset. In the present example, the second target preheat temperature Tₚ₂ is a fixed temperature (i.e., 510 °F) that is offset from the first target preheat temperature Tₚ₁ (i.e., by −40 °F) and is stored in the memory of the controller 80. The second preheat power scheme PH₁ will continuously deenergize the broil element 44 until the temperature Tₘ measured by the temperature sensor 82 is equal to or less than the second target preheat temperature Tₚ₂, and then cycle the broil element 44 according to a predetermined duty cycle to maintain the measured temperature Tₘ about the second target preheat temperature Tₚ₁. However, because the second preheating stage 210 is performed for a relatively short amount of time (e.g., 2 minutes), the temperature Tₘ measured by the temperature sensor 82 will likely not drop to or below the second target preheat temperature Tₚ₂. Accordingly, the second preheat power scheme PH₂ will simply deenergize the broil element 44 until the second preheat condition P₂ becomes satisfied. Moreover, because the cooking stone 94 has a relatively high thermal inertia, the cooking stone 94 will not significantly drop in temperature for the short duration of the second preheating stage 210.

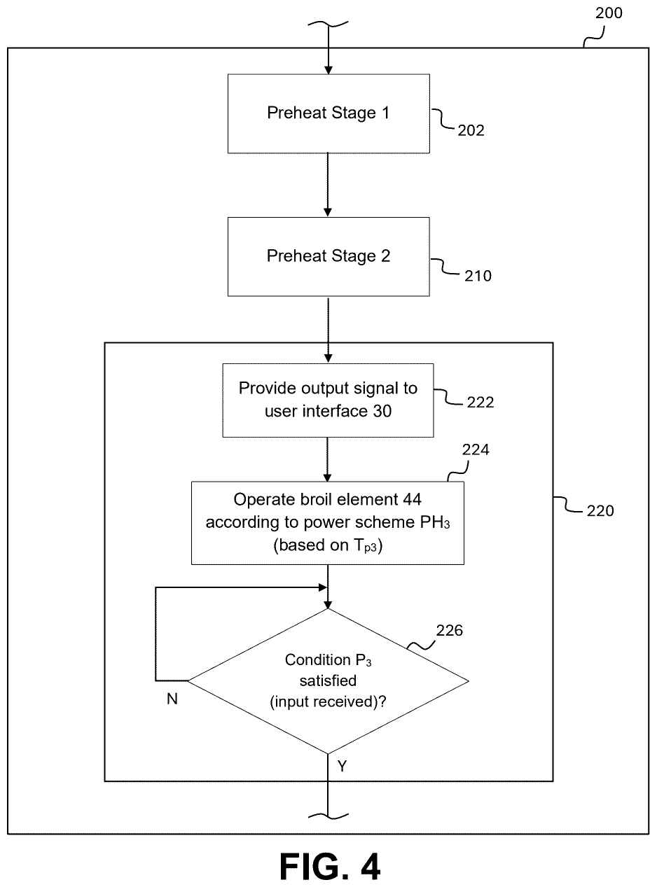

Once the second preheat condition P₂ becomes satisfied, the controller 80 will cease the second preheating stage 210 and proceed to the third (e.g., final) preheating stage 220 of the preheating operation 200. As shown in FIG. 4, the third preheating stage 210 includes an initial step 222 in which the controller 80 will provide an output signal to the user interface 30, which in turn will provide a notification (e.g., image, sound, light, etc.) to the user indicating that the cooking cavity 18 and cooking stone 94 are preheated and ready for cooking. The controller 80 will then operate the broil element 44 of the heating system 40 according to a third preheat power scheme PH₃ until a third preheat condition P₃ is satisfied indicating that a food item has been placed in the cavity 18 and is ready for cooking.

In particular, the controller 80 will perform a step 224 of operating the broil element 44 according to the third preheat power scheme PH₃ while waiting for the user to place a food item in the cooking cavity 18. While the broil element 44 is operated according to the third preheat power scheme PH₃, the controller 80 will perform a step 226 of determining whether a third preheat condition P₃ is satisfied, wherein the third preheat condition P₃ comprises the controller 80 receiving an input signal indicating that a food item has been placed in the cooking cavity 18 on the cooking stone 94. For example, a user may provide an input to the user interface 30 indicating that the food item is ready for cooking, and the user interface 30 can in turn provide an associated input signal to the controller 80. As another example, the controller 80 can receive an input signal from the door sensor 84, which can indicate that the door 22 has been opened and closed since the user was notified to place a food item in the cooking cavity 18. If the third preheat condition P₃ is not satisfied, the controller 80 will continue to operate the broil element 44 according to the third preheat power scheme PH₃ of the third preheating stage 210. However, once the third preheat condition P₃ becomes satisfied, the controller 80 will cease the third preheating stage 210 and proceed to the first cooking operation 300.

As discussed above, the second preheating stage 210 is designed to reduce the temperature of air within cooking cavity 18 before cooking. The third preheat power scheme PH₃ of the third preheating stage 220 is designed to keep the cooking cavity 18 at high temperature until the food item has been placed in the cooking cavity 18 and the third preheat condition P₃ becomes satisfied. In particular, the third preheat power scheme PH₃ is based on a third target preheat temperature Tₚ₃ (e.g., 530 °F) that is less than the first target preheat temperature Tₚ₁ (e.g., 550 °F) of the first preheating stage 202 but greater than the second target preheat temperature Tₚ₂ (e.g., 510 °F) of the second preheating stage 210. The third target preheat temperature Tₚ₃ is predetermined and can be a fixed temperature stored in the memory of the controller 80, or a calculated temperature that corresponds to a user-set temperature plus a negative predetermined offset (e.g., −20 °F). In the present example, the third target preheat temperature Tₚ₃ is a fixed temperature (i.e., 530 °F) that is offset from the first target preheat temperature Tₚ₁ (i.e., by −20 °F) and is stored in the memory of the controller 80. The third preheat power scheme PH₁ is configured to continuously deenergize the broil element 44 until the temperature Tₘ measured by the temperature sensor 82 is equal to or less than the third target preheat temperature Tₚ₃, and then cycle the broil element 44 according to a predetermined duty cycle to maintain the measured temperature Tₘ about the third target preheat temperature Tₚ₃.

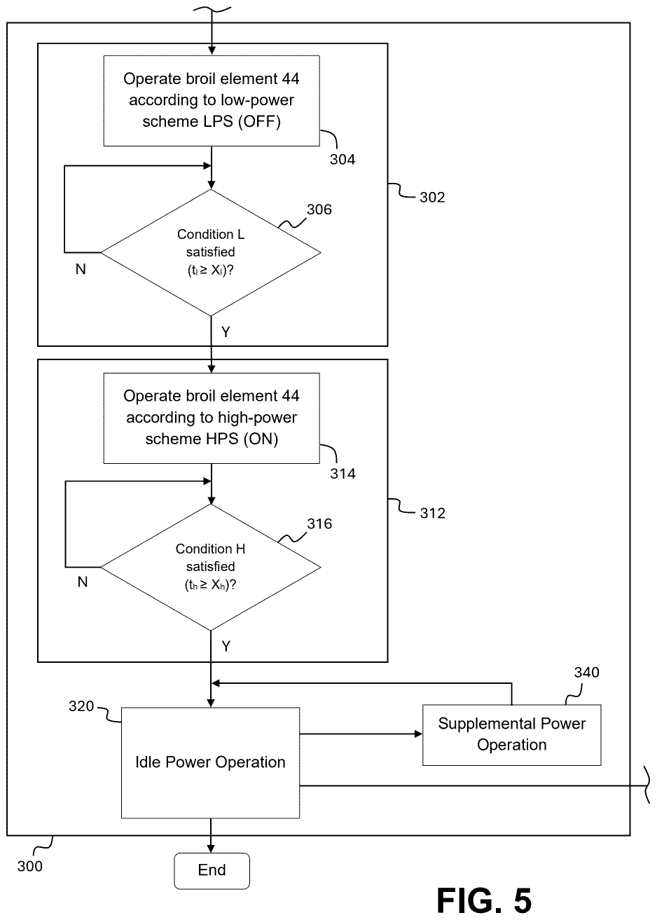

Turning FIG. 5, the controller 80 will perform the first cooking operation 300 in response to satisfaction of the third preheat condition P₃. The first cooking operation 300 includes a low-power operation 302 wherein the controller 80 will operate the broil element 44 according to a relatively low-power scheme LPS until a low-power condition L is satisfied. In particular, the low-power operation 302 includes an initial step 304 wherein the controller 80 will operate the broil element 44 according to the low-power scheme LPS, which in the present example continuously de-energizes the broil element 44 to maintain an OFF state. Moreover, the low-power operation 302 includes another step 306 in which the controller 80 will determine whether the low-power condition L is satisfied, wherein the low-power condition L comprises a time tₗ of operating the broil element 44 according to the low-power scheme LPS being greater than or equal to a predetermined threshold time Xₗ (e.g., 30 seconds). If the low-power condition L is not satisfied, the controller 80 will continue to operate the broil element 44 according to the low-power scheme LPS. However, once the low-power condition L becomes satisfied, the controller 80 will cease the low-power operation 302 and proceed to a high-power operation 312.

During the high-power operation 312, the controller 80 will operate the broil element 44 according to a relatively high-power scheme HPS until a high-power condition H is satisfied, wherein the high-power scheme HPS of the high-power operation 312 provides greater power than the low-power scheme LPS of the low-power operation 302. In particular, the high-power operation 312 includes an initial step 314 wherein the controller 80 will operate the broil element 44 according to the high-power scheme HPS, which continuously energizes the broil element 44 at full power to maintain an ON state. Moreover, the high-power operation 312 includes another step 316 in which the controller 80 will determine whether the high-power condition H is satisfied, wherein the high-power condition H comprises a time tₕ of operating the broil element 44 according to the high-power scheme HPS being greater than or equal to a predetermined threshold time Xₕ (e.g., 90 seconds). If the high-power condition H is not satisfied, the controller 80 will continue to operate the broil element 44 according to the high-power scheme HPS. However, once the high-power condition H becomes satisfied, the controller 80 will cease the high-power operation 312 and proceed to an idle-power operation 320 of the first cooking operation 310, which is described further below.

The low-and high-power operations 302, 312 described above are thus configured such that the low-power operation 302 will initially cook the food item with relatively low power for a first predetermined threshold time Xₗ (e.g., 30 seconds), and the high-power operation 312 will finish cooking the food item with relatively high power for a second predetermined threshold time Xₕ (e.g., 90 seconds). It is particularly advantageous to begin the cooking operation 300 with relatively low power to the broil element 44 so that the cooking stone 94 has sufficient time to conductively heat the bottom portion of the food item before the upper portion is overcooked by the combination of convective heat from the air and radiative heat from the broil element 44. Operating the broil element 44 at the low-power scheme LPS (e.g., continuously de-energized) during the low-power operation 302 will cause air temperature and the heat output of the broil element 44 to decrease (although the broil element 44 may still provide some heat output if, for example, it has residual heat and/or remains energized at a low level). Meanwhile, the cooking stone 94 will emit residual heat to conductively cook the food item resting thereon. Thus, the low-power operation 302 can begin cooking the lower portion of the food item while the cavity air and broil element 44 are providing relatively low heat output to the upper portion of the food item. Moreover, the high-power operation 312 will operate the broil element 44 at the high-power scheme HPS (e.g., continuously energized) to finish cooking the upper portion of the food item.

It is to be appreciated that the terms “low power” and “high power” as used herein denote relative powers and are not intended to denote any absolute values. Moreover, for the purposes of this disclosure, a high-power scheme can operate a heating system at greater power than a low-power scheme if the average or maximum power (i.e., rate of energy) supplied to the heating system during the high-power scheme is greater than the average or maximum power supplied to the heating system during the low-power scheme. For example, the low-power scheme LPS of the low-power operation 302 described above continuously de-energizes the broil element 44 to maintain an OFF state, whereas the high-power scheme HPS of the high-power operation 312 described above continuously energizes the broil element 44 at full power to maintain an ON state. Thus, the high-power scheme HPS operates the broil element 44 (and heating system 40 as a whole) at both greater average power and greater maximum power than the low-power scheme LPS of the low-power operation 302.

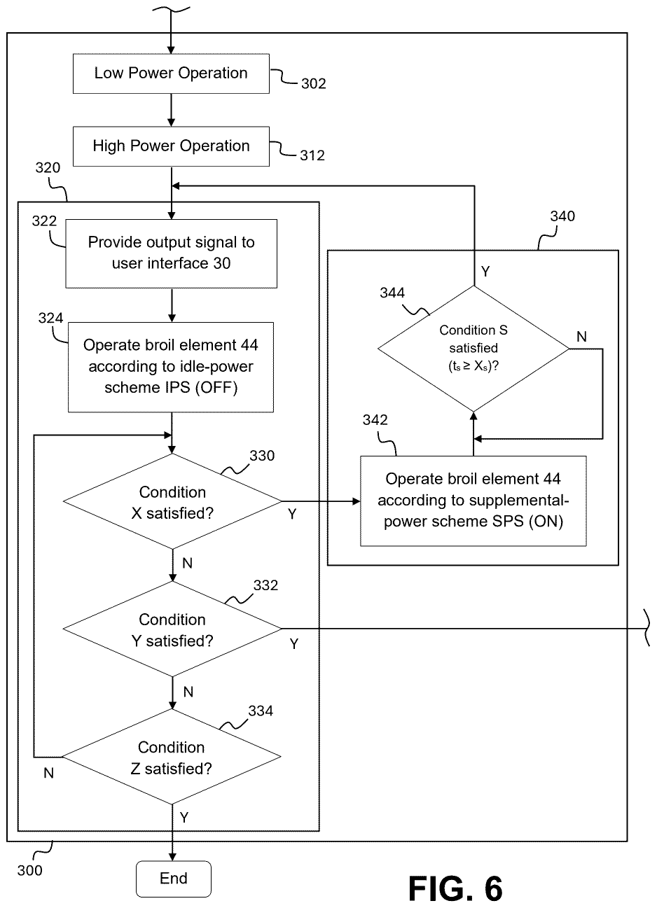

Turning to FIG. 6, the controller 80 will perform an idle-power operation 320 in response to completion of the high-power operation 312. The idle-power operation 320 includes an initial step 322 in which the controller 80 will provide an output signal to the user interface 30, which in turn will provide a notification (e.g., image, sound, light, etc.) to the user indicating that the high-power operation 312 is over and cooking should be complete. Moreover, the controller 80 will then operate the broil element 44 according to an idle-power scheme IPS until one of multiple alternative conditions X, Y, Z is satisfied indicating that either the food item is not fully cooked and needs further cooking, the food item has been removed and the user intends to cook another food item, or the food item has been removed and the high-heat cooking operation 100 can be terminated.

More specifically, the controller 80 will perform a step 324 of operating the broil element 44 according to the idle-power scheme IPS while waiting for the user to remove the food item from the cooking cavity 18 and/or provide further instruction to the controller 80. In the present example, the idle-power scheme IPS corresponds to (and thus continues) the high-power scheme HPS of the preceding high-power operation 312. In other examples, the idle-power scheme IPS can operate the broil element 44 at lower power than the high-power scheme HPS to prevent the idle-power operation 320 from potentially over cooking the food item. For example, the idle-power scheme IPS can continuously de-energize the broil element 44 to maintain an OFF state, whereas the high-power scheme HPS of the high-power operation 312 continuously energizes the broil element 44 at full power to maintain an ON state. Thus, in such examples, the high-power scheme HPS will operate the broil element 44 (and heating system 40 as a whole) at both greater average power and greater maximum power than the idle-power scheme IPS of the idle-power operation 320.

As the controller 80 operates the broil element 44 according to the idle-power scheme IPS, the controller 80 will perform steps 330, 332, 334 of determining whether a condition is satisfied from a group of idle conditions X, Y, Z. More specifically, the controller 80 will perform a step 330 of determining whether a first idle condition X is satisfied, wherein the first idle condition X comprises the controller 80 receiving a first input signal indicating that the food item not fully cooked and needs further cooking. For example, a user may provide an input to the user interface 30 indicating that the food item is not fully cooked, and the user interface 30 can in turn provide an associated input signal to the controller 80. If the first idle condition X is satisfied, the controller 80 will cease the idle-power operation 320 and proceed to a supplemental-power operation 340 that, as described further below, can continue cooking the food item for a predetermined amount of time. If the first idle condition X is not satisfied, the controller 80 will proceed to the next step 332 of the idle-power operation 320.

During the next step 332 of the idle-power operation 320, the controller 80 will determine whether a second idle condition Y is satisfied, wherein the second idle condition Y comprises the controller 80 receiving a second input signal indicating that the food item has been removed from the cooking cavity 18 and the user intends to cook another food item. For example, a user may provide an input to the user interface 30 indicating that the food item has been removed and the user intends to cook another food item, and the user interface 30 can in turn provide an associated input signal to the controller 80. If the second idle condition Y is satisfied, the controller 80 will cease the idle-power operation 320 and proceed to the reheat operation 400 which, as described further below, will prepare the cooking cavity 18 for the second food item. If the second idle condition Y is not satisfied, the controller 80 will proceed to the next step 334 of the idle-power operation 320.

During the next step 334 of the idle-power operation 320, the controller 80 will determine whether a third idle condition Z is satisfied, wherein the third idle condition Z comprises the controller 80 receiving a third input signal indicating that cooking is complete and the high-heating cooking operation 100 can be terminated. For example, a user may provide an input to the user interface 30 indicating that the high-heating cooking operation 100 can be terminated, and the user interface 30 can in turn provide an associated input signal to the controller 80. If the third idle condition Z is satisfied, the controller 80 will cease the high-heating cooking operation 100. However, if the third idle condition Z is not satisfied, the controller 80 will return to the step 330 of the idle-power operation 320. Moreover, the controller 80 will repeat the steps 330, 332, 332 accordingly (while operating the broil element 44 according to the idle-power scheme IPS) until one of the idle conditions X, Y, Z is satisfied, thus ending the idle-power operation 320.

As discussed above, the step 330 of the idle-power operation 320 will determine whether a first idle condition X is satisfied, wherein the first idle condition X comprises the controller 80 receiving an input signal indicating that the food item not fully cooked and needs further cooking. If the first idle condition X is satisfied, the controller 80 will cease the idle-power operation 320 and proceed to a supplemental-power operation 340 that can continue cooking the food item for a predetermined amount of time. The supplemental-power operation 340 will now be described in further detail.

During the supplemental-power operation 340, the controller 80 will operate the broil element 44 according to a supplemental-power scheme SPS until a supplemental-power condition S is satisfied. In particular, the supplemental-power operation 340 includes an initial step 342 in which the controller 80 will operate the broil element 44 according to the supplemental-power scheme SPS. In the present example, the supplemental-power scheme SPS continuously energizes the broil element 44 at full power to maintain an ON state. Moreover, the supplemental-power operation 342 includes another step 344 in which the controller 80 will determine whether the supplemental-power condition S is satisfied, wherein the supplemental-power condition S comprises a time tₛ of operating the broil element 44 according to the supplemental-power scheme SPS being greater than or equal to a predetermined threshold time Xₛ (e.g., 15 seconds).

If the supplemental-power condition S is not satisfied, the controller 80 will continue to operate the broil element 44 according to the supplemental-power scheme SPS. However, once the supplemental-power condition S becomes satisfied, the controller 80 will cease the supplemental-power operation 340 and return to the idle-power operation 320. Moreover, as discussed above, the idle-power operation 320 will provide an output indicating that cooking should be complete, and then operate the broil element 44 according to the idle-power scheme IPS while waiting for the user to remove the food item from the cooking cavity 18 and/or provide further instruction to the controller 80.

As discussed above, the step 332 of the idle-power operation 320 will determine whether a second idle condition Y is satisfied, wherein the second idle condition Y comprises the controller 80 receiving an input signal indicating that the food item has been removed from the cooking cavity 18 and the user intends to cook another food item. If the second idle condition Y is satisfied, the controller 80 will cease the idle-power operation 320 and proceed to the reheat operation 400, which will prepare the cooking cavity 18 for the second food item. The reheat operation 400 will now be described in further detail.

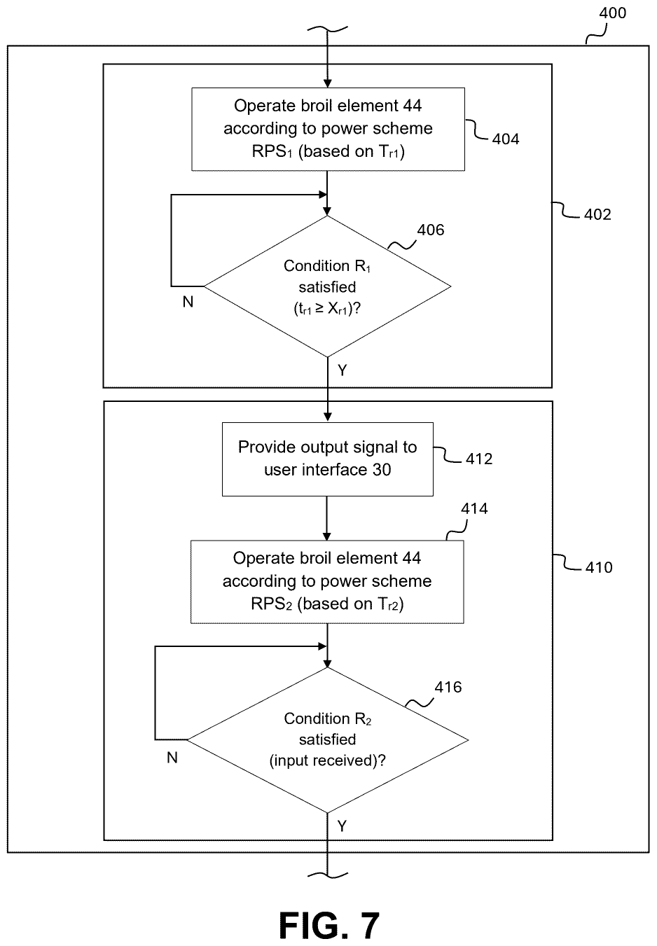

Turning to FIG. 7, the reheat operation 400 includes a first reheating stage 402 during which the controller 80 will operate the broil element 44 according to a first reheat power scheme RPS₁ until a first reheat condition R₁ is satisfied. In particular, the first reheating stage 402 includes an initial step 404 that will operate the broil element 44 according to the first reheat power scheme RPS₁. In the present example, first reheat power scheme RPS₁ is based on a first target reheat temperature Tᵣ₁ (e.g., 550 °F), which can be a fixed temperature stored in the memory of the controller 80, a user-set temperature that is set and provided to the controller 80 via the user interface 30, or an offset temperature that corresponds to a user-set temperature plus a positive or negative offset. The first reheat power scheme RPS₁ will continuously energize the broil element 44 at full power until the temperature Tₘ measured by the temperature sensor 82 is equal to or greater than the first target reheat temperature Tᵣ₁, and then cycle the broil element 44 according to a predetermined duty cycle to maintain the measured temperature Tₘ about the first target reheat temperature Tᵣ₁.

While the controller 80 operates the broil element 44 according to a first reheat power scheme RPS₁, the controller 80 will perform another step 406 of determining whether the first reheat condition R₁ is satisfied, wherein the first reheat condition R₁ comprises a time tᵣ₁ of operating the broil element 44 according to the first reheat power scheme RPS₁ being greater than or equal to a predetermined threshold time Xᵣ₁ (e.g., 3 minutes). If the first reheat condition R is not satisfied, the controller 80 will continue to operate the broil element 44 according to the first reheat power scheme RPS₁. However, once the first reheat condition R₁ becomes satisfied, the controller 80 will cease the first reheating stage 402 and proceed to a second reheating stage 410 of the reheating operation 400.

The second reheating stage 410 includes an initial step 412 in which the controller 80 will provide an output signal to the user interface 30, which in turn will provide a notification (e.g., image, sound, light, etc.) to the user indicating that the cooking cavity 18 and cooking stone 94 are reheated and ready for cooking the second food item. The controller 80 will then operate the broil element 44 of the heating system 40 according to a second reheat power scheme RPS₂ until a second reheat condition R₂ is satisfied indicating that a food item has been placed in the cavity 18 and is ready for cooking.

In particular, the controller 80 will perform a step 414 of operating the broil element 44 according to the second reheat power scheme RPS₂ while waiting for the user to place a food item in the cooking cavity 18. In the present example, the second reheat power scheme RPS₂ corresponds to (and thus continues) the first reheat power scheme RPS₁ described above. However, the second reheat power scheme RPS₂ may be different from the first reheat power scheme RPS₁ in some examples. For instance, in one example, the second reheat power scheme RPS₂ may continuously de-energize the broil element 44 to maintain an OFF state, such that the second reheat power scheme RPS₂ provides less power to the broil element 44 than the first reheat power scheme RPS₁.

While the broil element 44 is operated according to the second reheat power scheme RPS₂, the controller 80 will perform a step 416 of determining whether a second reheat condition R₂ is satisfied, wherein the second reheat condition R₂ comprises the controller 80 receiving an input signal indicating that a food item has been placed in the cooking cavity 18 on the cooking stone 94. For example, a user may provide an input to the user interface 30 indicating that the food item is ready for cooking, and the user interface 30 can in turn provide an associated input signal to the controller 80. As another example, the controller 80 can receive an input signal from the door sensor 84, which can indicate that the door 22 has been opened and closed since the user was notified to place a food item in the cooking cavity 18. If the second reheat condition R₂ is not satisfied, the controller 80 will continue to operate the broil element 44 according to the second reheat power scheme RPS₂ of the second reheating stage 410. However, once the second reheat condition R₂ becomes satisfied, the controller 80 will cease the second reheating stage 410 and proceed to the decision operation 500 of the high-heat cooking operation 100.

During the decision operation 500, the controller 80 will evaluate one or more conditions of the appliance 10 and/or cooking operation 100 to determine whether the second food item should be cooked with the first cooking operation 300 or a different/adjusted cooking operation (e.g., the second cooking operation 600). For example, the inventors have found that the amount of time between the start of the reheat operation 400 and the moment in which the second food item has been placed in the cooking cavity 18 (thus ending the reheat operation 400) can influence what cooking operation would be helpful for cooking the second food item with results similar to the first food item. That is, if the second food item is placed in the cooking cavity 18 within a certain amount of time (e.g., 4.5 minutes) since the start of the reheat operation 400, the first cooking operation 300 will tend to overcook the second food item relative to the first food item, and a different/adjusted cooking operation would be helpful to cook the second food item with similar results. However, if the second food item is placed in the cooking cavity 18 after that time, repeating the first cooking operation 300 will typically cook the second food item with similar results.

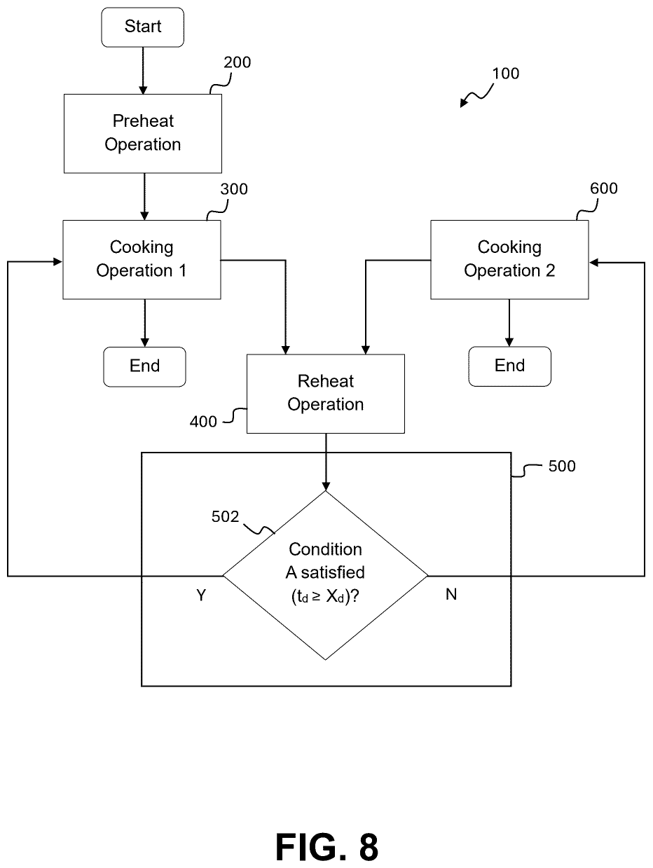

Accordingly, the decision operation 500 in the present example includes a step 502 (see FIG. 8) in which the controller 80 will determine whether a first cooking condition A is satisfied, wherein the first cooking condition A comprises a time t_{d} between the start and end of the reheat operation 400 (the end corresponding to satisfaction of the second reheat condition R₂, indicating that the second food item has been placed in the cooking cavity 18) being greater than or equal to a predetermined threshold time X_{d} (e.g., 4.5 minutes). If the first cooking condition A is satisfied, the controller 80 will perform the first cooking operation 300 as described above. However, if the first cooking condition A is not satisfied, the controller 80 will perform the second cooking operation 600, which is adjusted from the first cooking operation 300.

More specifically, the second cooking operation 600 is identical to the first cooking operation 300 except that the predetermined threshold times Xₗ, Xₕ of the low-and high-power operations 302, 312 have been adjusted for the second cooking operation 600. In particular, the predetermined threshold times Xₗ, Xₕ for the first cooking operation 300 are respectively 30 and 90 seconds, whereas the predetermined threshold times Xₗ, Xₕ for the second cooking operation 600 are respectively 80 seconds and 40 seconds. In other words, the second cooking operation 600 will have a longer low-power operation 302 and a shorter high-power operation 312 as compared to the first cooking operation 300.

In this manner, the high-heat cooking operation 100 can cook the second food item with similar results to the first food item, by either performing the first cooking operation 300 or the second cooking operation 600 depending on whether the first cooking condition A is satisfied during the decision operation 500. Moreover, during the idle-power operation 312 of the first/second cooking operation 300, 600, the user can provide an input signal to the controller 80 (via the user interface 30) to indicate that the second food item has been removed from the cooking cavity 18 and the user intends to cook another food item. As discussed above, this will satisfy the second idle condition Y at step 332 of the idle-power operation 320, thus causing the controller 80 to cease the idle-power operation 320 and proceed to the reheat operation 400 for the next food item. Moreover, once the reheat operation 400 is over, the controller 80 will again perform the decision operation 500 to determine whether the next food item should be cooked with the first cooking operation 300 or the second cooking operation 600. In this manner, the high-heat cooking operation 100 can cook multiple food items in sequence after the first food item, each time deciding which cooking operation 300, 600 should be performed to produce results similar to the first food item.

The high-heat cooking operation 100 as described above is thus useful for sequentially cooking multiple food items such as pizza at high heat and providing similar results for each food item. However, it is to be appreciated that the cooking operation 100 may be similarly applied to cook other types of food items at higher or lower temperatures. Moreover, although the cooking operation 100 in the present example only utilizes the broil element 44 of the heating system 40, the cooking operation 100 may utilize additional and/or alternative features of the heating system 40 such as the bake element 42, convection element 46, and/or convection fan 50.

Furthermore, the cooking operation 100 may comprise additional and/or fewer sub-operations than the sub-operations 200, 300, 400, 500, 600 described above, and each sub-operation may comprise additional or fewer steps than those described above. For instance, the cooking operation 100 may exclude the reheat operation 400 in some examples, and may simply perform the decision operation 500 in response to completion of the first or second cooking operation 300, 600. As another example, each cooking operation 300, 600 may exclude the supplemental-power operation 340 and its associated step 330 of determining whether the first idle condition X is satisfied.

Still further, although the cooking operation 100 in the present example only has two alternative cooking operations (i.e., the first cooking operation 300 and the second cooking operation 600), the high-heat cooking operation 100 may comprise additional alternative cooking operations without departing from the scope of the disclosure. In such examples, the decision operation 500 can comprise determining whether multiple cooking conditions are satisfied, wherein each cooking condition causes an associated one of the cooking operations to be performed. For example, the decision operation 500 can comprise the step 502 of determining whether the first cooking condition A is satisfied, wherein satisfaction of the first cooking condition A causes the first cooking operation 300 to be performed as described above. Moreover, the decision operation 500 can comprise additional steps of determining whether a second cooking condition B is satisfied and whether a third cooking condition C is satisfied, wherein satisfaction of the second cooking condition B causes the second cooking operation 600 to be performed and satisfaction of the third cooking condition C causes a third cooking operation to be performed that is different from the first and second cooking operations 300, 600.

Moreover, for the purposes of this disclosure, it is to be appreciated that a determination of whether a particular condition is satisfied can also be construed as a determination of whether an inverse of that condition is unsatisfied, and vice versa. For example, as discussed above, the decision operation 500 in the present example includes a step 502 in which the controller 80 will determine whether a first cooking condition A is satisfied, wherein the first cooking condition A comprises a time t_{d} between the start and end of the reheat operation 400 being greater than or equal to a predetermined threshold time X_{d} (e.g., 4.5 minutes). It is to be appreciated that this step 502 can also be construed as determining whether a second cooking condition B is satisfied, wherein the second cooking condition B corresponds to the inverse of the first cooking condition A (i.e., the time t_{d} being less than the predetermined threshold time X_{d}). That is, satisfaction of the first cooking condition A means the inverse second cooking condition B is unsatisfied, and unsatisfaction of the first cooking condition A means the inverse second cooking condition B is satisfied. Thus, the step 502 of determining whether the first cooking condition A is satisfied will effectively determine whether the second cooking condition B is satisfied. In response to the first cooking condition A being satisfied (i.e., the second cooking condition B being unsatisfied), the controller 80 will perform the first cooking operation 300. Moreover, in response to the first cooking condition A being unsatisfied (i.e., the second cooking condition B being satisfied), the controller 80 will perform the second cooking operation 600.

Lastly, it is to be appreciated that any of the conditions described above are open-ended, meaning that each condition can comprise additional elements that must occur for the condition to be satisfied. For instance, the first preheating stage 202 in the present example operates the broil element 44 according to the first preheat power scheme PH₁ until the first preheat condition P₁ is satisfied, wherein the first preheat condition P₁ comprises a time t_{P1} of operating the broil element 44 according to the first preheat power scheme PH₁ being greater than or equal to a predetermined threshold time X_{P1}. In some examples, the first preheat condition P₁ may further comprise the temperature Tₘ measured by the temperature sensor 82 being equal to or greater than the first target preheat temperature Tₚ₁, such that this element must also be satisfied before proceeding to the second preheating stage 210.

Illustrative embodiments have been described, hereinabove. It will be apparent to those skilled in the art that the above apparatuses and methods may incorporate changes and modifications without departing from the general scope of this disclosure. The disclosure is intended to include all such modifications and alterations disclosed herein or ascertainable herefrom by persons of ordinary skill in the art without undue experimentation.

What is claimed is:

1. A non-transitory computer-readable medium comprising a cooking program for a cooking appliance that includes a cooking cavity, a heating system having at least one heating element that is operable to heat air within the cooking cavity, and a controller that is operatively coupled to the heating system, wherein execution of the cooking program by the controller causes the controller to:
perform a preheat operation until a final preheat condition is satisfied, wherein the preheat operation comprises operating the heating system to preheat the cooking cavity;
perform a decision operation that comprises determining whether a first cooking condition or a second cooking condition is satisfied;
perform a first cooking operation in response to the first cooking condition being satisfied; and
perform a second cooking operation in response to the second cooking condition being satisfied, wherein the second cooking operation is different from the first cooking operation.

2. The non-transitory computer-readable medium according to claim 1, wherein the preheat operation comprises performing an initial preheating stage until an initial preheat condition is satisfied, the initial preheating stage comprising operating the heating system according to an initial preheat power scheme that is based on an initial preheat target temperature.

3. The non-transitory computer-readable medium according to claim 2, wherein the initial preheat condition is based on a predetermined threshold time.

4. The non-transitory computer-readable medium according to claim 2, wherein the preheat operation comprises performing a final preheating stage after the initial preheating stage, wherein the final preheating stage comprises the controller providing an output signal to a user interface of the cooking appliance.

5. The non-transitory computer-readable medium according to claim 4, wherein the final preheating stage comprises operating the heating system according to a final preheat power scheme that is based on a final preheat target temperature, wherein the final preheat target temperature is less than the initial preheat target temperature.

6. The non-transitory computer-readable medium according to claim 4, wherein the preheat operation comprises performing the second preheating stage until the final preheat condition is satisfied, wherein the final preheat condition comprises the controller receiving an input signal.

7. The non-transitory computer-readable medium according to claim 1, wherein the first cooking operation and second cooking operation each comprise operating the heating system according to a power scheme until a cooking condition is satisfied, the cooking condition of the first cooking operation being different than the cooking condition of the second cooking operation.

8. The non-transitory computer-readable medium according to claim 7, wherein for each of the first cooking operation and second cooking operation, the cooking condition is based on a predetermined threshold time, wherein the predetermined threshold time of the first cooking operation is different than the predetermined threshold time of the second cooking operation.

9. The non-transitory computer-readable medium according to claim 1, wherein the first cooking operation and second cooking operation each comprise:
a low-power cooking operation that comprises operating the heating system according to a low-power scheme until a low-power condition is satisfied, and
a high-power cooking operation that comprises operating the heating system according to a high-power scheme until a high-power condition is satisfied, the high-power scheme providing greater power to the heating system than the low-power scheme.

10. The non-transitory computer-readable medium according to claim 9, wherein:
the low-power scheme continuously de-energizes the heating system until the low-power condition is satisfied, and
the high-power scheme continuously energizes the heating system until the high-power condition is satisfied.

11. The non-transitory computer-readable medium according to claim 9, wherein the low-power condition and high-power condition of the first cooking operation are respectively different than the low-power condition and high-power condition of the second cooking operation.

12. The non-transitory computer-readable medium according to claim 9, wherein for each of the first cooking operation and second cooking operation, the low-power condition is based on a predetermined threshold time, wherein the predetermined threshold time of the first cooking operation is different than the predetermined threshold time of the second cooking operation.

13. The non-transitory computer-readable medium according to claim 9, wherein for each of the first cooking operation and second cooking operation, the high-power condition is based on a predetermined threshold time, wherein the predetermined threshold time of the first cooking operation is different than the predetermined threshold time of the second cooking operation.

14. The non-transitory computer-readable medium according to claim 9, wherein the high-power operation is performed in response to the low-power condition being satisfied.

15. The non-transitory computer-readable medium according to claim 1, wherein the first cooking operation and second cooking operation each comprise:
a high-power cooking operation that comprises operating the heating system according to a high-power scheme until a high-power condition is satisfied, and
an idle-power cooking operation that is performed in response to the high-power condition being satisfied, wherein the idle-power operation comprises:
providing an output signal to a user interface of the cooking appliance, and
operating the heating system according to an idle-power scheme that provides less power to the heating system than the high-power scheme.

16. The non-transitory computer-readable medium according to claim 15, wherein the idle-power operation comprises:
determining whether a first idle condition is satisfied, wherein the controller terminates the cooking program in response to the first idle condition being satisfied, and
determining whether a second idle condition is satisfied, wherein the controller terminates the idle-power operation and performs a reheat operation in response to the second idle condition being satisfied.

17. The non-transitory computer-readable medium according to claim 16, wherein the reheat operation comprises:
performing a first reheating stage until a first reheat condition is satisfied, the first reheating stage comprising operating the heating system according to a first reheat power scheme, and
performing a second reheating stage in response to the first reheat condition being satisfied, wherein the second reheating stage comprises:
providing an output signal to a user interface of the cooking appliance, and
operating the heating system according to a second reheat power scheme until a second reheat condition is satisfied, wherein the second reheat condition comprises the controller receiving an input signal.

18. The non-transitory computer-readable medium according to claim 17, wherein the first reheat power scheme is based on a first reheat target temperature, and the first reheat condition is based on a predetermined threshold time.

19. The non-transitory computer-readable medium according to claim 17, wherein the decision operation is performed in response to the second reheat condition being satisfied.

20. A method that comprises executing the cooking program of the non-transitory computer-readable medium according to claim 1, wherein execution of the cooking program causes the controller of the cooking appliance to:
perform the preheat operation until the final preheat condition is satisfied,
perform the decision operation,
perform the first cooking operation in response to the first cooking condition being satisfied, and
perform the second cooking operation in response to the second cooking condition being satisfied.
